(19) United States
(12) Patent Application Publication
(10) Pub. No.: US 2005/0192885 A1
(43) Pub. Date: Sep. 1, 2005

(54) Method and system for implementing integrated investment model

(76) Inventor: Robert V. Horowitz, Mill Valley, CA (US)

Correspondence Address: Khaled Shami;Thelen Reid & Priest LLP, P. O. Box 640640, San Jose, CA, 95164-0640, US

(21) Appl. No.: 10/787,758

(22) Filed: Feb. 27, 2004

(51) Int. Cl. G06F 17/60

(52) U.S. Cl. 705/36

(57) ABSTRACT

A method and system for displaying and manipulating investment portfolios provides side-by-side displays of projected wealth for easy comparison by the user. The comparison can be conducted between an existing current portfolio, and a hypothetical “What If” portfolio, each constructed based on a confluence of factors ranging from user preference to various diversification and optimization models. Input and changes to the portfolios can be implemented directly by manipulating portions of the display.

### CROSS-REFERENCE TO RELATE APPLICATIONS

(Not applicable)

### BACKGROUND OF THE INVENTION

1. Field of the Invention

The invention relates to an investment model which combines various approaches for meeting an investor's needs and displaying the impact of the investor's decisions.

2. Description of the Related Art

There are two major methodologies for assembling portfolios of investment securities. One is the optimal model and the other is what will herein be referred to as the preference model.

The optimal model, commonly referred to as Modern Portfolio Theory, got its start in Harry Markowitz's 1952 paper, “Portfolio Selection.” The purpose of Markowitz's work was to explains why investors normally buy a portfolio of stocks rather than a single stock. Until Markowitz, the prevailing assumption is that investors were concerned only with getting the highest possible return. Markowitz points out that buying multiple stocks is incompatible with the proposition that an investor cares only about gaining the highest possible return. A highest return strategy would require that an investor placed all funds in the single stock that held, according to his estimate, the potential for the highest return. Dividing funds among multiple stocks requires, by definition, including stocks with lower expected returns than the single stock with the highest expected return, and so lowers the expected return of the overall portfolio. The first key insight of “Portfolio Selection” is that investors diversify because they are concerned about risk as well as return.

The second key insight describes his theory of how rational investors would diversify their portfolios. Instead of simply buying a large number of similar stocks, they buy different types of stocks which could reasonably be expected to perform differently under different environments. For example, even though portfolios A and B hold an equal number of stocks, portfolio A is more diversified than B because it holds both technology and utility stocks while B only holds technology stocks. Securities that respond differently to the same events are called imperfectly correlated. Securities that move in exact lockstep are perfectly correlated. The less correlation between securities, the more diversified the portfolio. The more diversified, the less the risk as measured by standard deviation. Thus the riskiness of a portfolio is determined by the correlation between the securities in the portfolio rather than by the average riskiness of the individual securities. An efficient portfolio is one that is diversified to the point where it achieves the lowest possible risk (variability) for a given rate of return. Harry Markowitz along with Merton Miller and William Sharpe received the Noble prize in 1990 for their work on Modern Financial Theory. Today the optimal portfolio methodology is the preferred method of professional investment managers and financial service providers who have a strong academic influence.

The Preference methodology of creating portfolios of stocks gives primacy to investors' personal preferences for certain types of securities. In this model an investment advisor may suggest stable, dividend paying stocks to more traditional, older investors and high flying technology stocks to younger, more aggressive investors. In the preference model the characteristics of the individual securities including risk are reviewed independently. A low risk portfolio might contain only low-risk stocks. By contrast, the risk of individual securities in the optimal method is considered irrelevant. The only concern in the optimal model is how the individual security contributes to the risk of the overall portfolio. A risky stock with low correlation to the rest of the portfolio will actually reduce overall portfolio risk (as measured by standard deviation). As such, advisors using the optimal method consistently recommend that conservative investors include some high volatility stocks in their portfolios.

Both methods run into significant problems in terms of investor satisfaction and long run investment success. The optimal method attempts to persuade investors to buy securities they don't like. Convincing someone to buy something they don't want (a low preference portfolio) on the grounds that it is good for them is expensive, time-consuming, often fails and has a high rate of revisionism even when the sale succeeds. The last point is of particular concern for investors as long-term investor success requires that investors ride out inevitable periods of underperformance. Investors often abandon optimal portfolios as soon as they underperform because they never liked the stocks anyway. Underperformance just makes them more distasteful. As a result, they will likely lose money and have a failed investment experience. While the preference method normally leads to a portfolio that investors are eager to buy, inattention to overall portfolio risk can lead to significant and unacceptable losses. Because of these problems, practitioners of each method have begun to include aspects of the other method into their processes.

Almost all major financial service providers now include some sort of diversification framework in their advice. Additionally many now try to measure an individual's capacity to bear overall portfolio risk and attempt to create an overall portfolio that matches that risk profile. Similarly practitioners of the optimal method have begun to incorporate some elements of the preference model into their advice. The primary driving force has been investor resistance to including individual securities that they dislike just because the optimal model says it is the right thing to do. Over time optimal models have been adjusted to account for whether the investments are taxable or tax-protected. Additionally many of the optimal tools allow for veto power over certain securities. Normally an investor may exclude certain securities, categories of securities as well as entire asset classes. Some allow investors to specifically include certain favored securities.

Behavioral Economics

In the 1970s, Daniel Kahneman and Amos Tversky introduced Prospect Theory which questioned the assumptions of classical economic theory about how people make a decision when facing uncertain prospects. They found several areas where actual behavior proved different from classical expectations. First they found that people do not always prefer gambles with higher expected values over gambles with lower expected values. Given a choice between receiving a 50/50 bet on either receiving 1,000 or 0 and receiving 450 for certain, most people choose the certain 450, even though the amount is lower than the expected value of the bet (500). Second, they showed that integrating the gamble with the person's other assets changed the person's preference for gambles. While most people rejected the 50/50 gamble of either winning 15,000 or losing 10,000 when offered the bet directly, most accepted the gamble when asked to think of the bet not in terms of winning and losing the specific amounts but in terms of their total wealth. In other words people accepted the bet when they viewed the outcome as their total wealth (w)+15,000 or w−10,000 but rejected the gamble when excluding w from their thought process. Third, they showed that risk aversion changes depending on whether a person is facing a gain or loss. Rather than being equally risk averse when facing a gain or a loss, they found that people generally are more risk averse when facing a gain and in fact can become risk seeking when facing a loss. Inconsistencies between expected behavior and actual observed behavior continue to be unearthed by a variety of researchers. Daniel Kahneman shared the Nobel Prize in Economics with Vernon Smith in 2002 for their work in experimental and behavioral economics.

The overall conclusion is that investors will naturally make better decisions if their investment choices are presented in terms of their overall wealth.

Regret Analysis

In “Seeing Tomorrow” Ron Dembo and Andrew Freeman articulate the straightforward proposition that whenever we make a decision, we risk regretting it in the future. We may take a course of action and subsequently conclude that we wished we hadn't. For example, we may buy a particular stock and find that it goes down in price. We regret that we bought it. Conversely, we may decide not to buy a stock and find that it increases substantially in price. We regret not having bought the stock. In other words, no matter what we choose, we face the potential of regret. While this may seem obvious, Dembo and Freeman point out that a common decision making mistake is to look at only one side of the regret equation. We often look only at what can go right or only at what can go wrong. The consequences of only looking at one side of the equation can be disastrous. The investor that looks only at what can go right, risks loosing his family's life savings. The investor that looks only at what can go wrong misses out on wealth building opportunities that may substantially increase his welfare.

Regret Analysis points out that we need to look at both the potential gain and potential loss of our decisions simultaneously. With this type of framework, we can then evaluate all our options and choose the direction that risks that lowest amount of regret. How we weigh the regret is, of course, a personal decision. Each person will consider the value of gain or the pain of loss according to his/her own preferences. Current investor tools, such as Morningstar™'s Risk Analyzer (infra), are limited in that they only look at what can go wrong. From a regret analysis perspective they offer little to no value. They fail to allow the user to simultaneously view the potential upside and downside of his/her investment decisions.

U.S. Pat. No. 5,918,217 describes a user interface (UI) in which a user can interactively explore how changes in one or more input choices to a portfolio optimization model can affect one or more optimization outputs such as probability of achieving a financial goal or short term risk. User choice in this model is limited to establishing constraints on the optimization process. Constraints normally include risk tolerance, a savings level, retirement age, specific securities at specific amounts the user wants included in the portfolios. With the constraints the optimization engine determines a portfolio of securities (stocks, bonds and/or mutual funds) from a broad universe. Generally the engine optimizes by maximizing expected return and minimizes risk given the specified constraints. Normally the optimization engine considers several thousand potential portfolios before choosing the optimal portfolio. Other than controlling the universe of securities as well as specific securities to include, the user's interactivity is limited to controlling the constraints of the optimization engine. Normally, the optimization tool will present to the user a forecast of the optimized portfolios risk and reward characteristics by displaying various potential outcomes over various time periods.

Other prior art is represented by the online service Morningstar, including “Risk Analyzer.” This tool allows the user to view a portfolio's potential downside risk for varying time periods in a down market under various probability levels, and adjust the level of risk either “automatically” by clicking on higher and lower risk arrows or manually by adjusting the specific weights of securities in the portfolio. Feasibly a user could add securities not already existing in the portfolio as a way to adjust the risk levels. Additionally the tool shows the impact to overall portfolio risk of each security in the portfolio.

Further prior art allows the user to view the upside and downside under various probability levels of various asset allocation mixes. The user can manually adjust the level of a certain asset class and in real time see the effect in both dollar amounts and percentages over time and over a wide range of probabilities. This allows the user to interactively experiment with different asset allocations until the user determines a preferred asset allocation. An example of this type of tool is Morningstar.com's asset allocator.

A common forecasting method used is the factor building block approach. In this method, historical returns for major asset classes are broken down into constituent parts. For example, the return on large company stocks is broken down into two components or factors: (1) the risk-free return represented by the historical return on the 20-year U.S. Treasury bond; and (2) the equity risk premium which is the return of large company stocks in excess of the risk-free return. Future returns are then estimated by adding the historical equity risk premium to the current risk free rate for the appropriate time period. For example, assume that the historical annual risk premium for large company stocks is 5 percentage points above the risk free rate. To create a 5-year forecast one simply adds the historical premium, 5 percentage points, to the current 5 year U.S. Treasury bond rate. Assuming the bond rate is 5% then the 5 year expected return for large company stocks is 10% annually. One would use a similar method to determine the expected variance of those returns.

To then translate the historical asset class data into an expected return for an individual security, one may use a historical regression to determine the particular securities sensitivity to each considered factor. For example, if a regression showed that a particular stock was 10% more sensitive to the equity risk premium than the average stock, then its forecasted return would be the risk-free rate+110% of the equity risk premium resulting in a projected return of 10.5% annually.

Different methodologies may break down return components into many constituent parts or factors such as a small company, value premium or industry related factors. It is not uncommon for several dozen factors to be used in a forecasting engine. One method to forecast the return and variance of a portfolio is to sum the portfolio's return data and then forecast the entire portfolio as if it were a single security.

There are other methods both simpler and more complex for, achieving a portfolio forecast.

### BRIEF SUMMARY OF THE INVENTION

In accordance with one aspect of the invention, there is a provided a method for demonstrating the impact of security values on overall wealth in a portfolio. The method includes assembling a current portfolio of one or more securities and displaying the overall value of the current portfolio. The method further includes projecting the overall value of the current portfolio to one or more future points in time, each point in time having at least two current portfolio projections associated therewith, the first, optimistic current portfolio projection having a projected value above a current portfolio central forecasted value, the second, pessimistic current portfolio projection having projected value below the current portfolio central forecasted value. The method also includes displaying the optimistic and pessimistic current portfolio projections associated with at least one future point in time.

In accordance with another aspect of the invention, there is provided a computer-readable medium containing a program which executes a procedure of assembling a current portfolio of one or more securities, displaying the overall value of the current portfolio, projecting the overall value of the current portfolio to one or more future points in time, each point in time having at least two current portfolio projections associated therewith, the first, optimistic current portfolio projection having a projected value above a current portfolio central forecasted value, the second, pessimistic current portfolio projection having a projected value below the current portfolio central forecasted value, and displaying the optimistic and pessimistic current portfolio projections associated with at least one future point in time.

### BRIEF DESCRIPTION OF THE SEVERAL VIEWS OF THE DRAWINGS

Many advantages of the present invention will be apparent to those skilled in the art with a reading of this specification in conjunction with the attached drawings, wherein like reference numerals are applied to like elements, and wherein:

FIG. 1 is a view of a side-by-side portfolio summary screen depicting a Current Portfolio on the left-hand side and a hypothetical, What If portfolio on the right-hand side;

FIG. 2 is an outcome screen for the two portfolios depicted in FIG. 1;

FIG. 3 shows a personal computer system for use with the invention; and

FIG. 4 is a view of a network-connected computer system for use with the invention.

### DETAILED DESCRIPTION OF THE INVENTION

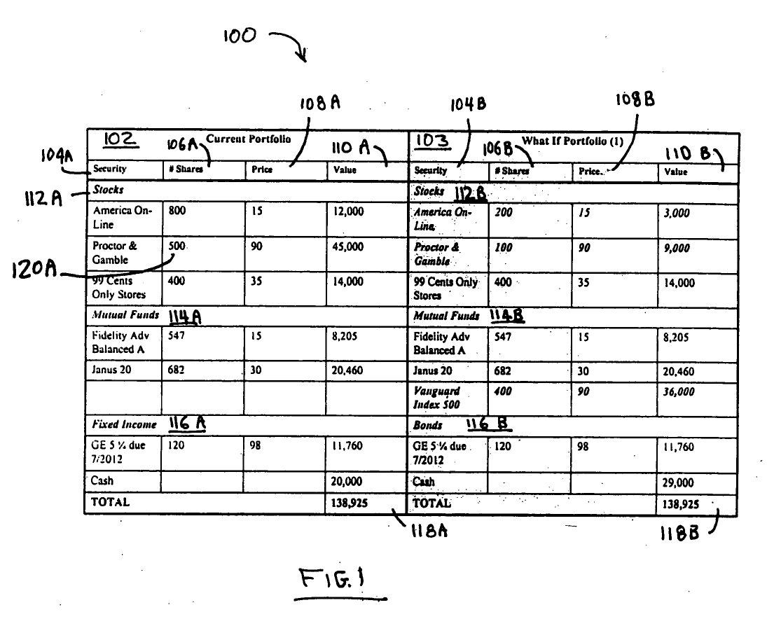

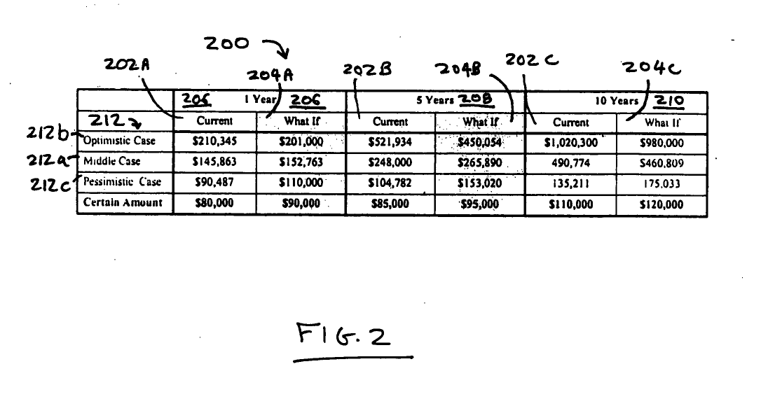

FIG. 1 illustrates a side-by-side portfolio summary screen 100 depicting a Current Portfolio 102 on the left-hand side and a hypothetical, What If portfolio 103 on the right-hand side. Each of the Current Portfolio 102 and the What If Portfolio 103 includes four columns dedicated respectively to the type of security (104A, 104B), the number of shares of the security (106A, 106B), the price-per-share of each security (108A, 108B), and the total value of that security (110A, 110B). The securities are categorized according to security group, and organized under the headings Stocks (112A, 1121B), Mutual Funds (114A, 114B), and Fixed Income (116A, 116B). Other headings are possible, and the display may be arranged in a different manner, and contain different information relating to the Current and the What If portfolios. Further, multiple what if scenarios may be displayed. The Current Portfolio 102 may be constructed based on any of the methodologies described above, including the preference model, optimal model, regret analysis, prospect theory and so forth. A combination of these may also be used. Construction may be automated and/or be based on broker recommendations or from other sources of expertise.

Both the Current Portfolio 102 and the What If Portfolio 103 have the same total value (18A, 118b) of $138,925. However, the securities in the portfolios are distributed differently, reflecting the user's intent to compare scenarios in which different securities are selected based on the same overall initial value, but accommodating the user's preference for different investments. Specifically, the side-by-side portfolio summary 100 of FIG. 1, depicts two portfolio scenarios, with the first (Current Portfolio 102) containing 800 shares of America Online, 500 shares of Proctor and Gamble, and $20,000 cash on the one hand, and the second (What If Portfolio 103) containing 200 shares of America Online, 100 shares of Proctor and Gamble, $29,000 cash, and 400 shares of Vanguard Index 500 securities on the other hand. Both portfolios have a common value (118A, 118b) of $138,925.

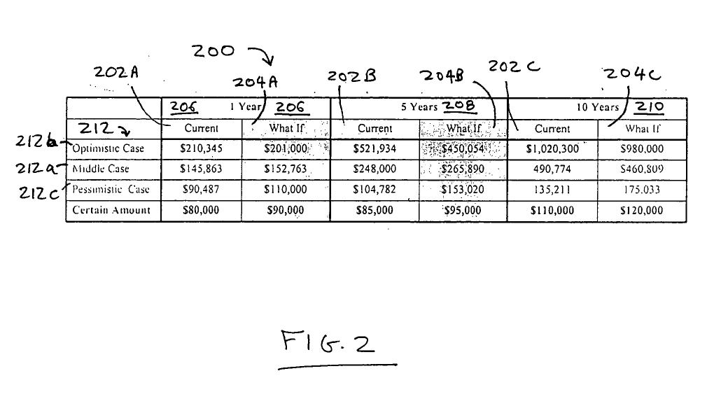

FIG. 2 shows the outcome screen 200 for the two portfolios depicted in FIG. 1. The contents of the outcome screen 200 are also arranged in side-by-side format, under the headings of Current (202A, 202B, 202C) and What If (204A, 204B, 204C) for 1-year (206), 5-year (208) and 10-year (210) projections. The outcome dollar figures populating screen 200 are determined using calculations and methodologies which can be selected from myriad different analytical and statistical tools available for projecting portfolio values into the future, including factor models and historical statistics methods using statistical averages and Monte Carlo simulations, for instance. One example of such methods is the factor building block approach described above. These in themselves do not form a part of the invention.

The left-most column 212 is a probabilistic designation assigned to the projected values depending on their relation to a central forecasted value (Middle Case 212a) which is determined by the known statistical and other computational tools available in the art. The central forecasted value could be a mean, median or mode value determined by the computational tools. The Optimistic Case, designated 212b, is a selected value above the central forecasted value—that is, above the mean, median or mode—and the Pessimistic Case (212c) is a selected value which is below.

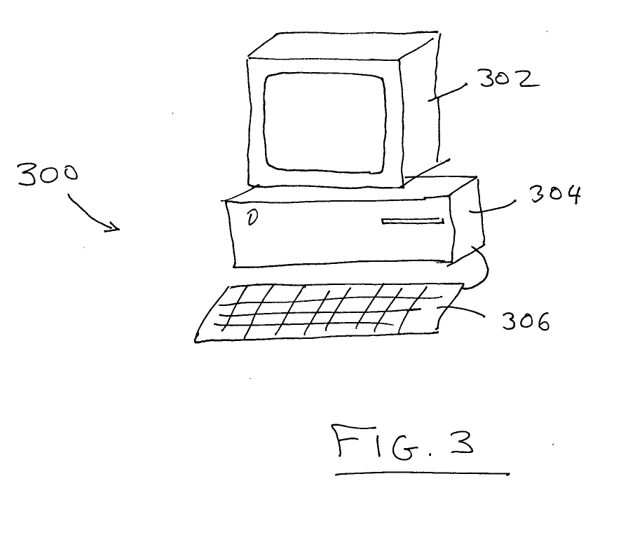

Screens 100 and 200 as shown in FIGS. 1 and 2 are displayed on computer display device 302, depicted in FIG. 3. Computer display device 302 can be part of a personal computer system 300, which includes a processing system 304, a keyboard 306, and a mouse 308. Processing system 304 can implement a computer program for performing calculations as necessary to obtain the outcome values displayed in screen 200 of FIG. 2, using data which can be manually entered into the system 300 via keyboard 306.

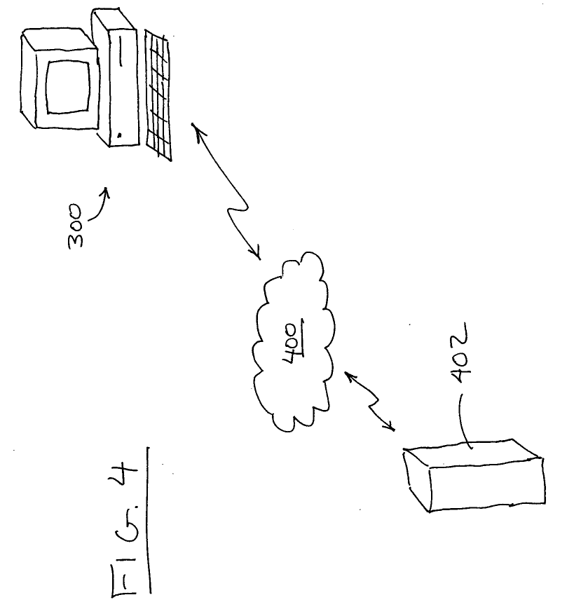

Alternatively, and more preferably, computer system 300 is connected through a network 400, shown in FIG. 4, to a server 402, and operates based on a client-server paradigm. The network 400 can for example be the Internet. Server 402 is represented as a single device, but it is to be understood that multiple servers, of varying functions, can be used as a service provider in a known manner. Computer system 300 contains a browser program through which communication with server 402 is effected, for example using HTML (Hypertext Markup Language). Computer system 300 has a computer readable medium such as RAM or a hard disk (not shown), which contains a program for obtaining from server 402 current values of securities contained in the Current (102) and What If (103) portfolios. These values can be made available, for example through the Internet, to server 402 from a myriad possible vendors and providers as is known in the art. The growth of the securities over time is then determined, either by the server system 402 or by computer system 300, and values representing this growth are displayed in outcome screen 200 by display device 302. Methods for determining and projecting growth over time are disclosed for example in U.S. Pat. No. 5,918,217, the teachings of which are incorporated herein by reference.

In one aspect of the invention, changes to the values of the securities can be implemented directly by interaction with the display screen. With reference to FIG. 1, the user can select a portion of the display screen, for example square 20A, and change the content of that square. Thus the number of Proctor & Gamble shares in the Current Portfolio can be changed from 500, and replaced with 100, to thereby construct the What If hypothetical portfolio. After this change, the projections are re-tabulated, either through computer system 300, or through network 400, to arrive at the outcome screen 200. Selection of a portion of the display screen is conducted using a suitable cursor control device, such as mouse 308, a trackball (not shown), and so forth. Alternatively, selection can be conducted using keyboard 306. In this manner, the user can experiment with different apportionments of securities to achieve a satisfactory portfolio, both in terms of its securities content, and in terms of optimum gains to be afforded thereby over the future points in time to which the values are projected.

The invention defines a methodology for integrating the Preference Investment model with the Optimal Investment model while incorporating the key learning of Prospect Theory. The result is a methodology that respects investor preferences regarding individual investments and strategies while presenting the overall portfolio risk and reward characteristics of their investment decisions to the investment decision maker. As the user experiments with the different investment ideas, he will directly see how his choices affect his overall portfolio risk and reward. He will then be able to make informed, intuitive decisions regarding both individual securities as well as the overall portfolio. It Presents impact of decisions in terms of future wealth or potential spending. Impact is presented in terms the upside, downside and expected result. Any probability estimate is allowed. Any time periods can be presented including the ability for the user to choose/adjust the time periods under consideration. The invention tool does all the calculations for the user. Any terms can be used to present the probability estimates. The tool may or may not present results in comparison to an alternative scenario. If an alternative scenario is used, there is no limit as to how many alternative scenarios can be used. The particular methodology, statistical tools used to make the calculations and forecasts are incidental.

The system of the invention can be configured to accommodate cash flows—both in and out. It can allow the user to try out different cash flow/investing policies—for example, dollar cost averaging, periodic additions, and so forth. By opening up different views, a user could choose how much money would be added to the account. For example, a user could $1,000 per month for 2 years. The system of the invention could assume it was invested in the same proportion as current assets.

The invention displays upside and downside of investments, and is interactive—that is, it can make adjustments and see results in real time or with delay of any period. It can include normal diversification tools as help (pie charts, sector diversification, and so forth). Asset allocation becomes a learning guide for improving risk/reward characteristic. Different views can be allowed, such as viewing the portfolio according asset class or sector. By buying securities in areas where the portfolio is underwighted, the user can improve the results displayed. Different cash flows can be included and adjusted for (for example, saving for a house, education, retirement, and so forth). The user may plan on receiving funds in the future such as a bonus that will be added to the investment portfolio. Multiple cash flow scenarios can be accommodated. The invention can include and adjust for taxes (realized and unrealized). Certain tax assumptions may be designed into the system. For example, it could assume that 5% of each year's return is lost in income taxes. The projected values in the table would be reduced by the amount of the tax assumptions. The invention can adjust for different timing of changes—for example, the addition of money to stocks in a subsequent year, as compared to the present. It can include any and all subjective criteria (for example, alpha, ratings expectations, etc.) Thus in addition to the projections based on standard models as discussed above, users may add additional criteria such as alpha. Which is the amount of securities return that is not accounted for the by the securities' riskiness. Displays can take place in any form, including graphs, tables, and so forth. Any type of grading system can be used to represent the upside or downside (a, b, c, etc.) to represent certain outcomes, rather than probabilities (5%, 50%, 95%). The invention can include all kinds of securities including derivatives like Bull CD's—behavioral finance implies that these types of securities may have great investor utility. It allows for segregating assets (multiple portfolios) and viewing them individually or in summary. It allows for segregating any aspect of the portfolio per grouping (risky vs. risk-free, asset class, type etc.) or individual security. Can be presented in summary or segregated. Any strategy or plan that is expressed with projections, codes impact of decisions in terms of final states of wealth or welfare. For example, if used to describe a strategy of buying and selling stocks. It shows dominance such as “what if” portfolio vs. current. It can include simplification methods, such as rounding of amounts or probabilities, with 49% becoming 50% probability. It can include any number of what if scenarios, or a series of comparisons, or multiple dominants. It includes the ability to ad-hoc edit the universe under consideration—that is, to exclude or re-include specific securities or groups of securities at any time during the process. It allows for comparison with any reference point. For example, the current portfolio does not have to be used. Other portfolios can be used for reference or comparison, such that of a friend or brother-in-law. It can be presented in gain or loss format. The projected end point is subtracted from current wealth. Instead of showing the expected values in the future, how much gained or lost can be displayed. The final value less the initial vestment amount can be shown.

The invention can display the forecasted results as an annuity stream rather than a lump-sum forecasted value. To convert a single value into an annuity stream the user would enter a starting and ending date for the annuity stream. The invention would then solve for the monthly or annual annuity value that would be equivalent to the single or lump sum value. The invention would then display the annuity values in the table rather than the original lump sum amount.

The above are exemplary modes of carrying out the invention and are not intended to be limiting. It will be apparent to those of ordinary skill in the art that modifications thereto can be made without departure from the spirit and scope of the invention as set forth in the following claims.

1. A method for demonstrating the impact of security values on overall wealth in a portfolio, the method comprising:
displaying a first portfolio having one or more securities;
projecting the overall value of the first portfolio to one or more future points in time, each point in time having at least two first portfolio projections associated therewith, including an optimistic first portfolio projection having a projected value above a first portfolio central forecasted value and a pessimistic first portfolio projection having a projected value below the first portfolio central forecasted value; and
displaying the optimistic and pessimistic first portfolio projections associated with at least one future point in time.

2. The method of claim 1, further comprising displaying the contribution of each security to the overall value of the first portfolio.

3. The method of claim 1, wherein the first portfolio central forecasted value is any of a mean, median or mode value.

4. The method of claim 1, further comprising:
changing the contribution of at least one security to thereby create a second portfolio;
projecting the overall value of the second portfolio to the one or more future points in time, each point in time having at least two second portfolio projections associated therewith, including an optimistic second portfolio projection having a projected value above a second portfolio central forecasted value and a pessimistic second portfolio projection having a projected value below the second portfolio central forecasted value; and displaying the optimistic and pessimistic second portfolio projections associated with at least one future point in time.

5. The method of claim 4, wherein the second portfolio central forecasted value is any of a mean, median or mode value.

6. The method of claim 1, further comprising displaying the first portfolio central forecasted value.

7. The method of claim 4, further comprising displaying the second portfolio central forecasted value.

8. The method of claim 7, wherein the optimistic and pessimistic first and second portfolio projections and the first and second portfolio central forecasted values are displayed in a side-by-side format.

9. The method of claim 4, further comprising displaying the contribution of each security to the overall value of the second portfolio.

10. The method of claim 4, wherein displaying the contribution of each security to the overall value of the first portfolio is conducted on a computer display, and wherein changing the contribution comprises selecting a portion of computer display and changing the content of said portion.

11. The method of claim 10, wherein selecting comprises using cursor control device and/or a keyboard.

12. A computer-readable medium containing a program which executes the following procedure:
displaying a first portfolio having one or more securities;
projecting the overall value of the first portfolio to one or more future points in time, each point in time having at least two first portfolio projections associated therewith, including an optimistic first portfolio projection having a projected value above a first portfolio central forecasted value and a pessimistic first portfolio projection having a projected value below the first portfolio central forecasted value; and
displaying the optimistic and pessimistic first portfolio projections associated with at least one future point in time.

13. The computer-readable medium of claim 12, wherein the procedure further comprises:
displaying the contribution of each security to the overall value of the first portfolio.

14. The computer-readable medium of claim 12, wherein the first portfolio central forecasted value is any of a mean, median or mode value.

15. The computer-readable medium of claim 12, wherein the procedure further comprises:
changing the contribution of at least one security to thereby create a second portfolio;
projecting the overall value of the second portfolio to the one or more future points in time, each point in time having at least two second portfolio projections associated therewith, including an optimistic second portfolio projection having a projected value above a second portfolio central forecasted value and a pessimistic second portfolio projection having a projected value below the second portfolio central forecasted value; and
displaying the optimistic and pessimistic second portfolio projections associated with at least one future point in time.

16. The computer-readable medium of claim 15, wherein the second portfolio central forecasted value is any of a mean, median or mode value.

17. The computer-readable medium of claim 12, the procedure further comprising displaying the first portfolio central forecasted value.

18. The computer-readable medium of claim 15, the procedure further comprising displaying the second portfolio central forecasted value.

19. The computer-readable medium of claim 18, wherein the optimistic and pessimistic first and second portfolio projections and the first and second central forecasted values are displayed in a side-by-side format.

20. The computer-readable medium of claim 15, the procedure further comprising displaying the contribution of each security to the overall value of the second portfolio.

21. The computer-readable medium of claim 15, wherein displaying the contribution of each security to the overall value of the first portfolio is conducted on a computer display, and wherein changing the contribution comprises selecting a portion of computer display and changing the content of said portion.

22. The computer-readable medium of claim 21, wherein selecting comprises using cursor control device and/or a keyboard.
